(19) United States
(12) Patent Application Publication
(10) Pub. No.: US 2024/0166527 A1
(43) Pub. Date: May 23, 2024

(54) AMMONIA AND WATER GENERATING WIND TURBINE

(71) Applicant: Rural Energy Corporation, St. Michael, MN (US)

(72) Inventor: Terry Anderson, Brookings, SD (US)

(21) Appl. No.: 18/499,608

(22) Filed: Nov. 1, 2023

Related U.S. Application Data
(60) Provisional application No. 63/427,539, filed on Nov. 23, 2022.

(51) Int. Cl. C01C 1/04; B01D 5/00; F03D 9/25

(52) U.S. Cl. CPC C01C 1/04; B01D 5/006; F03D 9/25

(57) ABSTRACT

A system for generating water and ammonia from atmospheric air includes a shaft, a rotatable blade assembly configured to drive the shaft, blade assembly configured to drive the shaft, an air filtration unit configured to receive and treat the atmospheric air, a radial compressor unit driven by the rotatable blade assembly via the shaft and disposed to compress the atmospheric air into compressed air, a nitrogen distillation unit configured to extract nitrogen from a first amount of the compressed air, a water condensing unit configured to condense water from a second amount of the compressed air, a hydrogen electrolysis unit configured to receive an amount of the water and to generate hydrogen from the amount of water, an electrochemical ammonia synthesis unit configured to receive the generated hydrogen from the hydrogen electrolysis unit and the extracted nitrogen from the nitrogen distillation unit, and to produce ammonia from the generated hydrogen and the extracted nitrogen, and an electric generator mechanically connected to the shaft and the blade assembly and electrically coupled to power the electrochemical ammonia synthesis unit and the hydrogen electrolysis unit. The shaft, the blade assembly, the air filtration unit, the radial compressor unit, the nitrogen distillation unit, the water condensing unit, the hydrogen electrolysis unit, the electrochemical ammonia synthesis unit, and the electric generator are contained within or attached to a common housing.

### CROSS-REFERENCE TO RELATED APPLICATION(S)

This application claims the benefit of U.S. Provisional Application No. 63/427,539 filed Nov. 23, 2022 for “AMMONIA AND WATER GENERATING WIND TURBINE” by T. Anderson and R. Cornelius.

### BACKGROUND

The present disclosure relates generally to water and ammonia generation, and more particularly to a wind turbine system configured to generate both water and ammonia from atmospheric air.

### SUMMARY

A system for generating water and ammonia from atmospheric air includes a shaft, a rotatable blade assembly configured to drive the shaft, blade assembly configured to drive the shaft, an air filtration unit configured to receive and treat the atmospheric air, a radial compressor unit driven by the rotatable blade assembly via the shaft and disposed to compress the atmospheric air into compressed air, a nitrogen distillation unit configured to extract nitrogen from a first amount of the compressed air, a water condensing unit configured to condense water from a second amount of the compressed air, a hydrogen electrolysis unit configured to receive an amount of the water and to generate hydrogen from the amount of water, an electrochemical ammonia synthesis unit configured to receive the generated hydrogen from the hydrogen electrolysis unit and the extracted nitrogen from the nitrogen distillation unit, and to produce ammonia from the generated hydrogen and the extracted nitrogen, and an electric generator mechanically connected to the shaft and the blade assembly and electrically coupled to power the electrochemical ammonia synthesis unit and the hydrogen electrolysis unit. The shaft, the blade assembly, the air filtration unit, the radial compressor unit, the nitrogen distillation unit, the water condensing unit, the hydrogen electrolysis unit, the electrochemical ammonia synthesis unit, and the electric generator are contained within or attached to a common housing.

A method of operating a wind turbine system to generate water and ammonia from atmospheric air includes receiving and treating, by an air filtration unit of the system, atmospheric air, compressing, by a radial compressor unit of the system, the atmospheric air, receiving, by a nitrogen distillation unit of the system, a first amount of the atmospheric air and extracting nitrogen from the first amount of the atmospheric air, receiving, by a water condensing unit of the system, a second amount of the atmospheric air and condensing water from the second amount of the atmospheric air, receiving, by a hydrogen electrolysis unit of the system, an amount of the water and generating hydrogen from the amount of water, and receiving, by an electrochemical ammonia synthesis unit of the system, the extracted nitrogen from the nitrogen distillation unit and the generated hydrogen from the hydrogen electrolysis unit, and producing ammonia from the extracted nitrogen and the generated hydrogen.

### BRIEF DESCRIPTION OF THE DRAWINGS

FIG. 1 is a schematic block diagram of a wind turbine system for generating water and ammonia.

While the above-identified FIGURE sets forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The FIGURE may not be drawn to scale, and applications and embodiments of the present invention may include features and components not specifically shown in the drawings.

### DETAILED DESCRIPTION

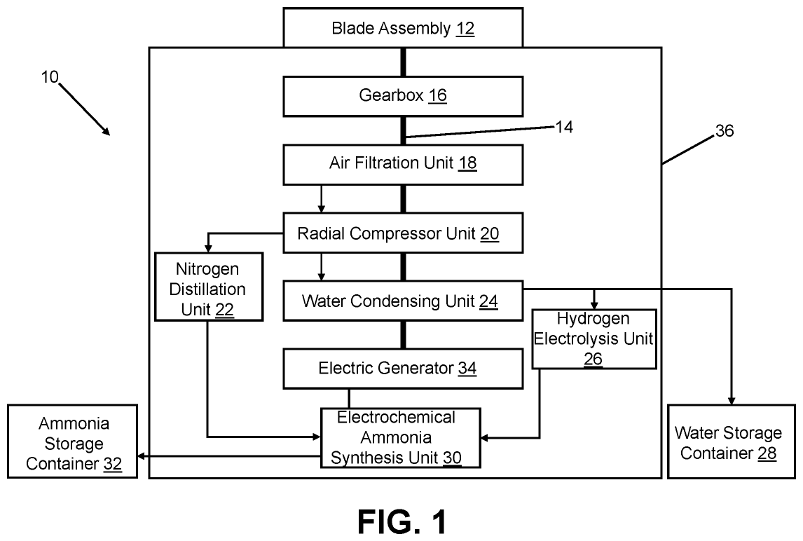

FIG. 1 is a block diagram that schematically illustrates wind turbine system 10 capable of producing and storing water and ammonia from atmospheric air. The representation of this system provided herein does not necessarily represent the only division or arrangement of mechanical components. Other components can also be included in the system, and equivalents or functionally analogous variations on the elements described and illustrated herein can be substituted freely without departing from the scope and spirit of the present disclosure.

System 10 includes blade assembly 12, which can for example be a horizontal or vertical three-blade wind turbine. Shaft 14 mechanically couples blade assembly 12 to other components of the system, as shown. In the most general case, shaft 14 need not be a single mechanical shaft, but can more broadly be any mechanism by which components of the system are coupled to blade assembly 12, and in some embodiments to other components. Gearbox 16 is operatively connected to blade assembly 12 and shaft 14 for converting the low-speed, high-torque power generated by blade assembly 12 to high-speed, low-torque power. Although only one gearbox 16 and one shaft 14 are depicted for simplicity of illustration, in some contemplated embodiments any of the loads driven by rotation of blade assembly 12 (e.g., air filtration unit 18, radial compressor 20, water condensing unit 24, electrochemical ammonia synthesis unit 30, and/or electric generator 34) can be connected by appropriate drive shafts and/or gearing.

Air filtration unit 18 is a filtration device, and radial compressor unit 20 is an air compressor. Air, e.g., atmospheric air, is cleaned/treated by air filtration unit 18 before entering radial compressor unit 20. Air filtration unit 18 can, for example, be a multi-stage filter. Radial compressor unit 20 can, for example, be a multiple cylinder radial compressor. Compressing the air allows the separation of both nitrogen (i.e., diatomic nitrogen, N₂) and water (H₂O) from the air.

Compressed air from radial compressor unit 20 is delivered to nitrogen distillation unit 22, which extracts pure nitrogen for ammonia generation. Water condensing unit 24 condenses water from compressed air received from radial compressor unit 20. A portion of this condensed water is delivered to hydrogen electrolysis unit 26 for hydrogen generation, while the remainder of the condensed water is retained in water storage container 28, which can be any type of fluidly sealable vessel suitable for storing water. In one example, water storage container 28 can be an underground container.

Hydrogen electrolysis unit 26 splits water into hydrogen (i.e., diatomic hydrogen, H₂) and oxygen. Hydrogen produced in this way is delivered to electrochemical ammonia synthesis unit 30. Electrochemical ammonia synthesis unit 30 can be any appropriate ammonia fixation device suited to produce pure ammonia (NH₃) using hydrogen from hydrogen electrolysis unit 26 and nitrogen from nitrogen distillation unit 22. Electrochemical ammonia synthesis unit 30 can be any ammonia fixing system, such as a membrane-assisted autothermal reforming system using the Haber-Bosch process. Ammonia produced by electrochemical ammonia synthesis unit 30 is delivered to ammonia storage container 32, e.g., as anhydrous ammonia. Like water storage container 28, ammonia storage container 32 can be any fluidly sealable vessel suitable for storing aqueous ammonia. Ammonia storage container 32 can further be an underground container in one example, which facilitates thermal regulation (i.e., cooling) of the stored ammonia.

Electrical components including hydrogen electrolysis unit 26 and electrochemical ammonia synthesis unit 30 can be electrically coupled to and powered by electric generator 34, which can be any form of electric generator driven mechanically by rotation of blade assembly 12, via shaft 14, with speed and torque converted by gearbox 16.

In one example, blade assembly 12, shaft 14, gearbox 16, air filtration unit 18, radial compressor unit 20, nitrogen distillation unit 22, water condensing unit 24, hydrogen electrolysis unit 26, electrochemical ammonia synthesis unit 30, and electric generator 34 can be housed within and/or otherwise attached to common housing 36, which can include any type of housing found in wind turbines, such as a nacelle, tower, or both. In another example, water storage container 28 and/or ammonia storage container 32 can also be collocated with the remaining components of system 10 within housing 36.

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for generating water and ammonia from atmospheric air, the system comprising:
a shaft;
a rotatable blade assembly configured to drive the shaft;
an air filtration unit configured to receive and treat the atmospheric air;
a radial compressor unit driven by the rotatable blade assembly via the shaft and disposed to compress the atmospheric air into compressed air;
a nitrogen distillation unit configured to extract nitrogen from a first amount of the compressed air;
a water condensing unit configured to condense water from a second amount of the compressed air;
a hydrogen electrolysis unit configured to receive an amount of the water and to generate hydrogen from the amount of water;
an electrochemical ammonia synthesis unit configured to receive the generated hydrogen from the hydrogen electrolysis unit and the extracted nitrogen from the nitrogen distillation unit, and to produce ammonia from the generated hydrogen and the extracted nitrogen; and
an electric generator mechanically connected to the shaft and the blade assembly and electrically coupled to power the electrochemical ammonia synthesis unit and the hydrogen electrolysis unit,
wherein the shaft, the blade assembly, the air filtration unit, the radial compressor unit, the nitrogen distillation unit, the water condensing unit, the hydrogen electrolysis unit, the electrochemical ammonia synthesis unit, and the electric generator are contained within or attached to a common housing.

2. The system of claim 1 and further comprising: an ammonia storage container fluidly connected to the electrochemical ammonia synthesis unit and configured to receive and store the ammonia.

3. The system of claim 2, wherein the ammonia storage container is an underground storage container.

4. The system of claim 2 and further comprising: a gearbox operatively connected to the shaft and the blade assembly.

5. The system of claim 2 and further comprising: a water storage container fluidly connected to the water condensing unit and configured to receive and store a remainder of the water.

6. The system of claim 5, wherein the water storage container is an underground storage container.

7. The system of claim 5, wherein the blade assembly is a three-blade wind turbine.

8. The system of claim 7, wherein the common housing comprises at least one of a nacelle and a tower of the wind turbine.

9. The system of claim 5, wherein the air filtration unit comprises a multi-stage air filter.

10. The system of claim 5, wherein the radial compressor unit is multiple cylinder radial compressor.

11. The system of claim 5, wherein the nitrogen distillation unit comprises a membrane-assisted autothermal reforming system.

12. A method of operating a wind turbine system to generate water and ammonia from atmospheric air, the method comprising:
receiving and treating, by an air filtration unit of the system, atmospheric air;
compressing, by a radial compressor unit of the system, the atmospheric air;
receiving, by a nitrogen distillation unit of the system, a first amount of the atmospheric air and extracting nitrogen from the first amount of the atmospheric air;
receiving, by a water condensing unit of the system, a second amount of the atmospheric air and condensing water from the second amount of the atmospheric air;
receiving, by a hydrogen electrolysis unit of the system, an amount of the water and generating hydrogen from the amount of water; and
receiving, by an electrochemical ammonia synthesis unit of the system, the extracted nitrogen from the nitrogen distillation unit and the generated hydrogen from the hydrogen electrolysis unit, and producing ammonia from the extracted nitrogen and the generated hydrogen.

13. The method of claim 12 and further comprising: rotating, using a rotatable blade assembly of the system, a shaft of the system to drive an electric generator of the system.

14. The method of claim 13, wherein the rotatable blade assembly is a three-blade wind turbine.

15. The method of claim 13 and further comprising: powering the electrochemical ammonia synthesis unit and the hydrogen electrolysis unit using the electric generator.

16. The method of claim 13 and further comprising: storing a remainder of the water condensed by the water condensing unit in a water storage container of the system.

17. The method of claim 13 and further comprising: storing the ammonia produced by the electrochemical ammonia synthesis unit in an ammonia storage container.

18. The method of claim 17, wherein the stored ammonia is anhydrous ammonia.
